(19) United States
(12) Patent Application Publication
(10) Pub. No.: US 2006/0066703 A1
(43) Pub. Date: Mar. 30, 2006

(54) Image recording apparatus and image recording method

(75) Inventors: Tetsuzo Kadomatsu, Ashigara-Kami-Gun (JP); Masaaki Konno, Ashigara-Kami-Gun (JP)

Correspondence Address: BIRCH STEWART KOLASCH & BIRCH, PO BOX 747, FALLS CHURCH, VA, 22040-0747, US

(73) Assignee: Fuji Photo Film Co.

(21) Appl. No.: 11/237,708

(22) Filed: Sep. 29, 2005

(30) Foreign Application Priority Data
Sep. 30, 2004 (JP) 2004-288782

(51) Int. Cl. B41J 2/01

(52) U.S. Cl. 347/102; 347/101

(57) ABSTRACT

The image recording apparatus comprises: a recording head which ejects a recording liquid having properties of being cured by irradiation of radiation, onto a recording medium; a relative conveyance device which causes the recording head and the recording medium to move relatively to each other in a relative conveyance direction; a radiation irradiating device which irradiates the radiation onto recording liquid deposited on the recording medium; and a pressurization device which pressurizes the recording liquid which has been irradiated with the radiation, the pressurization device being provided on a downstream side of the recording head in the relative conveyance direction of the relative conveyance device, the pressurization device having the radiation irradiating device provided inside thereof and having one of a transmissive member capable of transmitting the radiation emitted from the radiation irradiating device to exterior and a structure capable of transmitting the radiation to the exterior, wherein a pressurization start position of the pressurization device at which pressurization of the recording liquid on the recording medium starts is situated further to the downstream side of the recording head in the relative conveyance direction of the relative conveyance device than an irradiation start position of the radiation irradiating device.

### BACKGROUND OF THE INVENTION

1. Field of the Invention

The present invention relates to an image recording apparatus and an image recording method, and more particularly, to image formation technology for forming images on media using a radiation-curable ink which is cured by irradiation of radiation, such as ultraviolet light, an electron beam, or the like.

2. Description of the Related Art

In recent years, inkjet recording apparatuses have come to be used widely as data output apparatuses for outputting images, documents, or the like. By driving nozzles provided in a print head in accordance with data, an inkjet recording apparatus is able to form data onto a medium, such as recording paper, by means of ink ejected from the nozzles.

Depending on the type of recording media and the type of ink used, the deposited ink may permeate into the recording media, giving rise to bleeding or spreading on the dots formed on the recording medium, and thus leading to a marked deterioration in image quality.

In order to prevent image deterioration due to bleeding and spreading of the dots as described above, technology has been proposed which uses a radiation-curable ink in which curing of the ink is promoted by irradiating ultraviolet light, an electron beam, or the like, onto the ink, and hence the ink droplets deposited on the recording medium are cured and fixed rapidly, bleeding and deformation (spreading) of the dots formed on the recording medium, and color mixing between inks of different colors, is prevented, and image deterioration is avoided.

The recording apparatus described in Japanese Patent Application Publication No. 2003-136697 is a recording apparatus having a variable information printing unit for printing variable information to the outside of the print region of fixed information on a recording medium. The variable information recording unit uses an inkjet head which ejects ink having properties of being cured by irradiation of ultraviolet light or an electron beam. When printing variable information, the thickness of the ink is made to coincide with that of the fixed information, by setting the thickness of the ink droplets on the recording medium printed by the variable information recording unit to ±15 μm of the thickness of the fixed information, or setting the thickness of the actual ink droplets to 15 μm or less.

In the recording apparatus described in Japanese Patent Application Publication No. 2002-283545, an intermediate transfer device temporarily holds ink ejected from a recording head and transfers the ink onto a recording medium in a transfer section, and a first light irradiating device which irradiates light for curing the ink held on the intermediate transfer device is provided inside the intermediate transfer device. Furthermore, in addition to the first light irradiating device, a second light irradiating device is provided between the first light irradiating device and the transfer section, to the outer side of the intermediate transfer device, in such a manner that the viscosity of the ink on the intermediate transfer device can be controlled.

The recording apparatus described in Japanese Patent Application Publication No. 2002-283546 comprises an intermediate transfer device which temporarily holds ink ejected from a recording head and transfers the ink to a recording medium in a transfer section, and a cleaning device which removes ink remaining on the intermediate transfer device after transfer, by means of a cleaning blade. A supply roller which supplies a low-friction film forming member for forming a film having a low coefficient of friction is provided on the upstream side of the cleaning blade in the direction of rotation of the intermediate transfer device, in such a manner that occurrence of recording faults due to residual material on the intermediate transfer device after cleaning is prevented.

In the recording apparatus described in Japanese Patent Application Publication No. 2002-283555, an intermediate transfer device temporarily holds ink ejected from a recording head and transfers the ink onto a recording medium in a transfer section, and a first light irradiating device which irradiates light for curing the ink held on the intermediate transfer device is provided inside the intermediate transfer device. Furthermore, in addition to the first light irradiating device, a second light irradiating device is provided for curing the ink at a desired timing and a desired location, and by altering the glossiness in accordance with the type of image being recorded, an image which is appealing to the user can be recorded.

However, in an inkjet system which uses ultraviolet-curable ink, for example, if the ink droplets on the recording medium are cured by irradiation of ultraviolet light, then the printed section is formed with a thickness, and this may appear as a visible relief (step difference) in the recorded image.

In the recording apparatus described in Japanese Patent Application Publication No. 2003-136697, a grinding apparatus, pressurization apparatus and a heating apparatus are described as processing units for adjusting the height (thickness) of the ink on the recording medium, but there is no disclosure regarding the relationship between the timing at which the ink droplets are cured, and the timing at which the height of the ink droplets is adjusted by the processing unit. Therefore, it is difficult to adjust the height of the ink droplets to a height within a prescribed range, in accordance with the state of curing of the ink droplets.

Furthermore, in the recording apparatuses described in Japanese Patent Application Publication Nos. 2002-283545, 2002-283546 and 2002-283555, there is no particular mention of technology for leveling the ink held temporarily on the intermediate transfer device or the ink transferred onto the recording medium.

### SUMMARY OF THE INVENTION

The present invention has been contrived in view of the foregoing circumstances, an object thereof being to provide an image recording apparatus and an image recording method whereby the occurrence of step differences between the ink and the media and between inks is avoided by leveling of ultraviolet-curable ink on a recording medium, and hence desirable images free of visible relief effects can be formed.

In order to attain the aforementioned object, the present invention is directed to an image recording apparatus, comprising: a recording head which ejects a recording liquid having properties of being cured by irradiation of radiation, onto a recording medium; a relative conveyance device which causes the recording head and the recording medium to move relatively to each other in a relative conveyance direction; a radiation irradiating device which irradiates the radiation onto recording liquid deposited on the recording medium; and a pressurization device which pressurizes the recording liquid which has been irradiated with the radiation, the pressurization device being provided on a downstream side of the recording head in the relative conveyance direction of the relative conveyance device, the pressurization device having the radiation irradiating device provided inside thereof and having one of a transmissive member capable of transmitting the radiation emitted from the radiation irradiating device to exterior and a structure capable of transmitting the radiation to the exterior, wherein a pressurization start position of the pressurization device at which pressurization of the recording liquid on the recording medium starts is situated further to the downstream side of the recording head in the relative conveyance direction of the relative conveyance device than an irradiation start position of the radiation irradiating device.

According to the present invention, the recording liquid ejected from a recording head and deposited on a recording medium is irradiated by a radiation irradiating device, and is then leveled by pressurization by a pressurization device. Furthermore, since the radiation irradiating device is provided inside the pressurization device, and the pressurization device is composed in such a manner that it can transmit the radiation emitted from the radiation irradiating device, then it is possible to irradiate radiation until immediately before pressurization by the pressurization device (in other words, the irradiation of radiation and the pressurization of the recording liquid droplets can be performed substantially simultaneously in the same plane), and furthermore, a curing process by irradiation of radiation can also be carried during and after pressurization by the pressurization device, thus making it possible to maintain the shape of the ink droplets which have been leveled by pressurization.

The radiation includes light, such as ultraviolet light, electron beams, and the like, and regardless of the wavelength of the radiation used, it should contain curing energy for applying to the recording liquid on the recording medium.

The recording liquid includes various types of liquids which can be ejected in the form of droplets from ejection holes (nozzles) of an ejection head, such as ink, resist, liquid chemical, treatment liquid, and the like.

The recording head may be a full line type head in which ejection holes are arranged through a length corresponding to the entire width of the recording medium, or a serial type head (shuttle scanning type head) in which a short head having ejection holes arranged through a length that is shorter than the entire width of the recording medium ejects liquid droplets onto the recording medium while scanning in the breadthways direction of the recording medium (main scanning direction).

A full line ejection head may be formed to a length corresponding to the full width of the recording medium by combining short head having rows of ejection holes which do not reach a length corresponding to the full width of the ejection receiving medium, these short heads being joined together in a staggered matrix fashion.

Moreover, “recording medium” indicates a medium which receives a recording liquid ejected from a recording head, and this term includes various types of media, irrespective of material and size, such as continuous paper, cut paper, sealed paper, resin sheets, such as OHP sheets, film, cloth, and other materials. The “recording medium” may also be referred to as “recording media, print medium, ejection receiving medium”, and so on.

Preferably, the radiation irradiating device cures the recording liquid in such a manner that an interior of the recording liquid on the recording medium has a liquid state or a semi-solidified state.

Since the recording liquid is cured to a state where it can be leveled by the pressurization device, leveling by the pressurization device can be performed readily, and furthermore, since the surface of the recording liquid droplets are cured, it is possible to prevent adherence of the recording liquid to the pressurization device.

A desirable mode for curing the recording liquid in such a manner that the interior of the recording liquid has a liquid state or a semi-solidified (gel) state is one in which the recording liquid is cured to a state in which leveling by the pressurization device is possible and furthermore scattering of the recording liquid does not occur upon contact of the pressurization device with the recording liquid. More desirably, the recording liquid is cured to a state in which the recording liquid will not adhere to the portions of the pressurization device which make contact with the recording liquid, when the pressurization device makes contact with the recording liquid, and when the recording liquid is pressed by the pressurization device.

More specifically, the recording liquid is cured by irradiation of radiation to a state in which it has flexibility that allows deformation of the recording liquid droplets when the recording liquid is pressurized (a transient, intermediate state during the change from a liquid to a solid).

Preferably, the image recording apparatus further comprises a relative conveyance control device which controls the relative conveyance device in such a manner that a relationship between a time period T1 from a start of the irradiation of the radiation onto the recording liquid on the recording medium from the radiation irradiating device until a start of the pressurization of the recording liquid on the recording medium by the pressurization device, and a time period T2 from the start of the irradiation of the radiation onto the recording liquid on the recording medium from the radiation irradiating device until the recording liquid is cured to a state where an interior of the recording liquid is in a liquid state or a semi-solidified state and the recording liquid is capable of being leveled by the pressurization device, satisfies the following relationship: T1>T2.

By making the time period T2 from the start of irradiation of radiation onto the recording liquid on the recording medium until the recording liquid is cured in such a manner that the interior of the recording liquid has a liquid state or semi-solidified state, shorter than the time period T1 from the start of irradiation of radiation onto the recording liquid on the recording medium until the start of pressurization by the pressurization device, it is possible to prevent scattering of the recording liquid, or adherence of the recording liquid onto the pressurization device, when the recording liquid is pressurized.

In order to satisfy this relationship between T1 and T2, it is possible to vary the conveyance speed of the relative conveyance device, or it is possible to vary the position or irradiation range of the radiation irradiating device.

If the conveyance speed of the relative conveyance device can be varied, then T1 can be shortened by increasing the conveyance speed of the relative conveyance device, and T1 can be lengthened by reducing the conveyance speed. Desirably, the conveyance speed of the relative conveyance device is altered in accordance with the type of recording medium, the type of recording liquid, the environment (temperature, humidity, etc.), and the like.

Preferably, the relative conveyance control device controls the relative conveyance device in such a manner that a relationship between the time period T1, and a time period T3 from the start of the irradiation of the radiation onto the recording liquid on the recording medium from the radiation irradiating device until the recording liquid is fully cured to a state where the recording liquid cannot be leveled by the pressurization device, satisfies the following relationship: T1<T3.

By making the time period T1 from the start of irradiation of radiation onto the recording liquid on the recording medium until the start of pressurization by the pressurization device, shorter than the time period T3 from the start of irradiation of radiation onto the recording liquid on the recording medium until the recording liquid is cured to a state where it cannot be leveled by the pressurization device, it is possible to carry out the leveling process by the pressurization device in a reliable manner.

More specifically, the conveyance speed of the conveyance device may be controlled, or the position and irradiation range of the radiation irradiating device may be controlled, in such a manner that the values T1, T2 and T3 stated in claim 3 and claim 4 satisfy the relationship T2<T1<T3.

Preferably, the image recording apparatus further comprises a pressure varying device which varies pressure applied to the recording liquid on the recording medium by the pressurization device.

Since a composition is adopted in which the pressure applied to the recording liquid by the pressurization device can be varied in accordance with the type of recording medium and the type of recording liquid, it is possible to achieve a desirable leveling process, even when various types of recording media and recording liquids are used.

Preferably, the pressurization device comprises a recording liquid removal device which removes the recording liquid that has attached to a surface of the pressurization device during pressurization of the recording liquid.

By removing recording liquid that has become attached to the pressurization device during the leveling process, it is possible to prevent transfer of the recording liquid attached to the pressurization device onto the recording medium during the next leveling process.

A desirable mode is one in which a recovery device is provided for recovering the recording liquid, and foreign matter other than the recording liquid, which has been removed from the pressurization device.

Preferably, the recording head comprises a plurality of recording heads; and the pressurization device is provided for each of the recording heads, each pressurization device being disposed on the downstream side of the corresponding recording head in the relative conveyance direction of the relative conveyance device.

Since a pressurization device and a radiation irradiating device are provided for each recording head in cases where there are a plurality of recording heads, then it is possible to perform a leveling process by means of a pressurization device with respect to the recording liquid ejected by each recording head, and therefore, a desirable leveling process is performed for each recording liquid emitted from the respective recording heads, and a desirable image can be recorded on the recording medium.

The modes for providing a plurality of recording heads include a mode in which a recording head is provided for each respective color in a recording head which records color images. If a leveling process is performed for each color, then a desirable image free of non-uniformities between colors can be obtained.

Alternatively, it is also preferable that the recording head comprises a plurality of recording heads; and the pressurization device is provided commonly for the plurality of recording heads, on a furthest downstream side of the recording heads in the relative conveyance direction of the relative conveyance device.

If a common pressurization device and radiation irradiating device are provided for the plurality of recording heads, then the composition of the apparatus can be simplified.

Preferably, the image recording apparatus further comprises a movement device which moves the radiation irradiating device in at least one of a direction having a component substantially parallel to the relative conveyance direction of the relative conveyance device, and a direction having a component substantially perpendicular to the relative conveyance direction of the relative conveyance device.

By composing the radiation irradiating device in such a manner that it is movable, it is possible to vary the position and size of the irradiation region of the radiation irradiated onto the recording liquid on the recording medium, and therefore a desirable curing state of the recording liquid can be obtained in accordance with the type or recording medium and recording liquid.

Preferably, the image recording apparatus further comprises: an amount-of-radiation modification device which modifies an amount of the radiation emitted by the radiation irradiating device; and an amount-of-radiation modification control device which controls the amount-of-radiation modification device in such a manner that, when the radiation irradiating device is moved by the movement device, an amount of the radiation necessary to cure the recording liquid so that an interior of the recording liquid has a liquid state or a semi-solidified state is irradiated onto the recording liquid on the recording medium, by means of the pressurization device.

By moving the radiation irradiating device, the amount of radiation irradiated onto the recording liquid on the recording medium may be decreased (or increased), and the state of curing of the recording liquid may not remain uniform. Therefore, the amount of radiation emitted from the radiation irradiating device is made to be variable in such a manner that a uniform (constant) amount of radiation is irradiated onto the recording liquid on the recording medium, even if the radiation irradiating device is moved. Consequently, it is possible to achieve a stable curing state of the recording liquid at all times.

In order to attain the aforementioned object, the present invention is also directed to an image recording method, comprising the steps of: ejecting a recording liquid having properties of being cured by irradiation of radiation, onto a recording medium; curing the recording liquid in such a manner that an interior of the recording liquid deposited on the recording medium in the ejecting step has a liquid state or a semi-solidified state; and pressurizing the recording liquid after the recording liquid has been cured in the curing step in such a manner that the interior of the recording liquid has the liquid state or the semi-solidified state.

According to the present invention, a radiation irradiating device is provided inside a pressurization device which pressurizes and levels a radiation-curable type of recording liquid deposited on a recording medium, and furthermore, the pressurization device is composed in such a manner that it transmits the radiation emitted from the radiation irradiating device. Therefore, a leveling process is carried out after curing the recording liquid to a state which is suitable for leveling, and hence a desirable image is recorded by means of a suitable leveling process, and adherence of the recording liquid to the pressurization device is prevented.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a basic schematic drawing of an inkjet recording apparatus relating to an embodiment of the present invention;

FIG. 2 is a plan view of the principal part of the peripheral printing region of the inkjet recording apparatus shown in FIG. 1;

FIGS. 3A to 3C are plan perspective views showing an example of the composition of a print head;

FIG. 4 is a cross-sectional diagram along section 4-4 in FIGS. 3A to 3C;

FIG. 5 is a principal block diagram showing the system configuration of the inkjet recording apparatus;

FIG. 6 is a schematic drawing showing the composition of the peripheral area of the print unit shown in FIG. 1;

FIG. 7 is a schematic drawing showing the composition of a pressurization roller and preliminary curing light source shown in FIG. 1;

FIG. 8 is an approximate schematic drawing of a mode in which an ultraviolet light amount variation function is provided in the preliminary curing light source shown in FIG. 7;

FIG. 9 is a diagram showing one mode of the ultraviolet light amount variation function shown in FIG. 7;

FIG. 10 is a diagram showing a further mode of the ultraviolet light amount variation function shown in FIG. 7; and

FIG. 11 is a basic schematic drawing of an inkjet recording apparatus relating to a modification of the present embodiment.

### DETAILED DESCRIPTION OF THE PREFERRED EMBODIMENTS

General Composition Of Inkjet Recording Apparatus

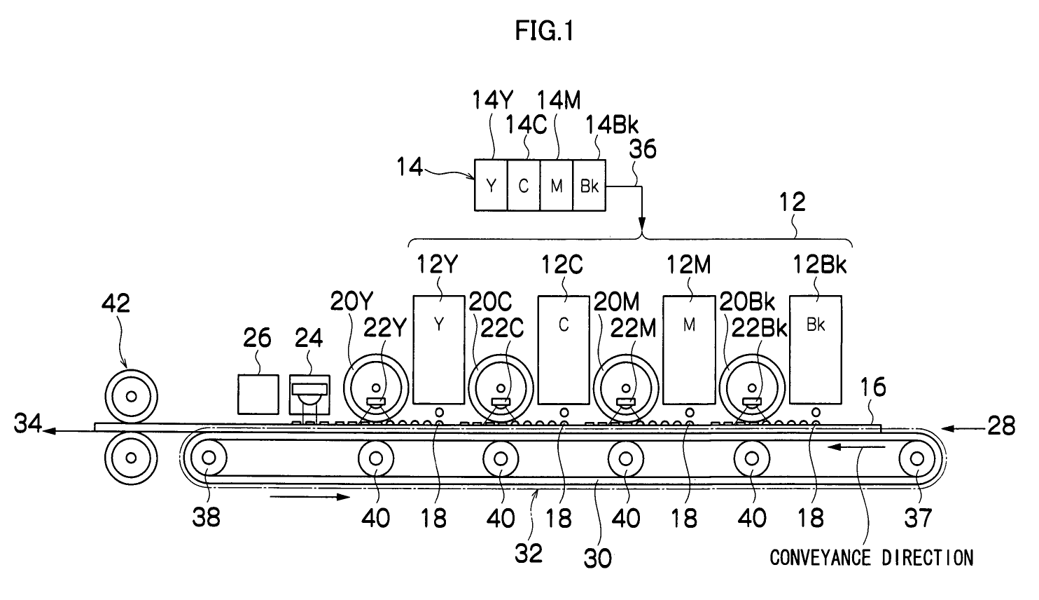

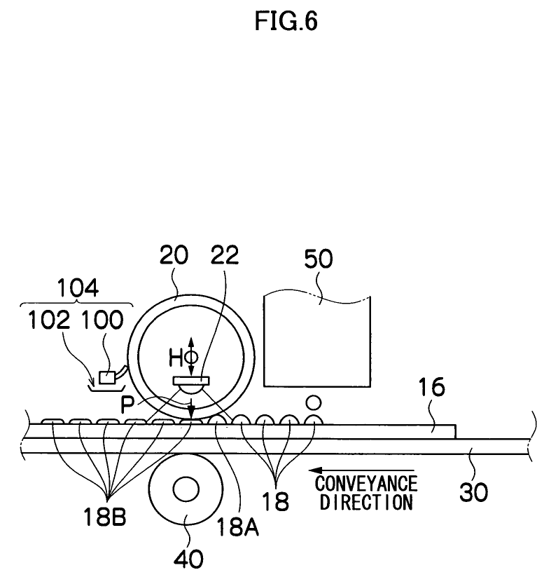

FIG. 1 is a diagram of the general composition of an inkjet recording apparatus relating to an embodiment of the present invention. As shown in FIG. 1, this inkjet recording apparatus 10 comprises: a print unit 12 having a plurality of print heads 12Bk, 12M, 12C and 12Y provided corresponding to the respective ink colors; an ink storing and loading unit 14 for storing ultraviolet-curable ink to be supplied to the print heads 12Bk, 12M, 12C and 12Y; pressurization rollers 20Bk, 20M, 20C, and 20Y, disposed respectively on the downstream side of the print heads 12Bk, 12M, 12C and 12Y in the conveyance direction of the recording paper 16 (the direction indicated by the arrow in FIG. 1), for performing a leveling process which levels the ink droplets 18 deposited onto the recording paper 16 (in other words, which aligns the heights of the ink droplets 18); cleaning blades, which are not shown in FIG. 1 (but are indicated by reference numeral 100 in FIG. 6), provided at the respective pressurization rollers 20Bk, 20M, 20C and 20Y, for removing ink adhering to the surface of the pressurization rollers 20Bk, 20M, 20C and 20Y; ultraviolet (UV) light sources 22Bk, 22M, 22C and 22Y, which irradiate ultraviolet light onto the ink droplets 18 in such a manner that the ink droplets are cured preliminarily before the leveling process for the ink droplets 18; a main curing light source 24, provided on the downstream side of the print unit 12 in the recording paper conveyance direction, which irradiates ultraviolet light onto the ink droplets 18 in order to perform main curing of the ink droplets 18 which have undergone a leveling process; a print determination unit 26 which reads in the print results from the print unit 12; a paper supply unit 28 which supplies recording paper (recording medium or media) 16; a belt suction conveyance unit 32, disposed facing the nozzle surface (ink ejection surface) of the print heads 12Bk, 12M, 12C and 12Y, which conveys the recording paper 16 while suctioning (fixing) the recording paper 16 onto a belt 30 in such a manner that it is dept flat; and a paper output unit 34 which outputs the recorded recording paper 16 (printed matter) to the exterior.

The ink storing and loading unit 14 has ink tanks 14Bk, 14M, 14C, 14Y for storing the inks of the colors corresponding to the print heads 12Bk, 12C, 12M, and 12Y, and the ink tanks are connected to the print heads 12Bk, 12C, 12M, and 12Y through prescribed channels 36. The ink storing and loading unit 14 also comprises a warning device (for example, a display device or an alarm sound generator) for warning when the remaining amount of any ink is low, and has a mechanism for preventing loading errors among the colors.

In the present embodiment, a magazine (not shown) containing roll paper (continuous paper) is used as the recording paper 16. It is also possible to use jointly a plurality of magazines containing papers of different widths and qualities, and the like. Moreover, papers may be supplied in cassettes that contain cut papers loaded in layers and that are used jointly or in lieu of magazines for rolled papers.

In the case of a configuration in which roll paper is used, a shearing cutter (not shown) is provided on the downstream side of the magazine of the roll paper, and the roll paper is cut to a desired size by the cutter. The cutter has a stationary blade, of which length is not less than the width of the conveyor pathway of the recording paper 16, and a round blade, which moves along the stationary blade. The stationary blade is disposed on the reverse side of the printed surface of the recording paper 16, and the round blade is disposed on the side adjacent to the printed surface across the conveyance path. When cut paper is used, the cutter is not required.

In the case of a configuration in which a plurality of types of media can be used, it is preferable that an information recording medium such as a bar code and a wireless tag containing information about the type of media is attached to the magazine, and by reading the information contained in the information recording medium with a predetermined reading device, the type of media to be used is automatically determined, and ink droplet ejection is controlled so that the ink droplets are ejected in an appropriate manner in accordance with the type of media.

The recording paper 16 delivered from the paper supply unit 28 retains curl due to having been loaded in the magazine. In order to remove the curl, heat is applied to the recording paper 16 in the decurling unit (not shown) by a heating drum (not shown) in the direction opposite from the curl direction in the magazine. The heating temperature at this time is preferably controlled so that the recording paper 16 has a curl in which the surface on which the print is to be made is slightly round outward.

After decurling, the cut recording paper 16 is delivered to the belt suction conveyance unit 32. The belt suction conveyance unit 32 has a configuration in which an endless belt 30 is set around rollers 37 and 38 in such a manner that at least the portion of the endless belt 30 facing the nozzle faces of the print heads 12Bk, 12M, 12C and 12Y forms a horizontal plane (flat plane).

The belt 30 has a width that is greater than the width of the recording paper 16, and a plurality of suction apertures (not shown) are formed on the belt surface. A suction chamber (not shown) is disposed in a position facing the sensor surface of the print determination unit 26 and the nozzle surface of the print unit 12 on the interior side of the belt 30, which is set around the rollers 37 and 38; and the suction chamber provides suction by means of a pump (not shown) to generate a negative pressure, thereby holding the recording paper 16 onto the belt 30 by suction.

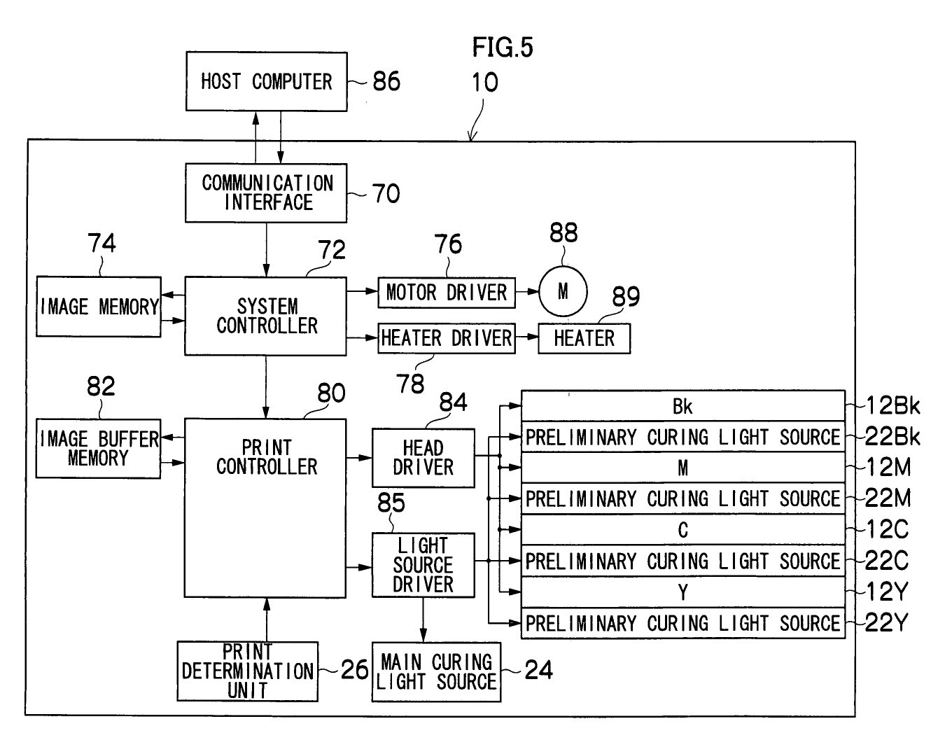

The belt 30 is driven in the counterclockwise direction in FIG. 1 by the motive force of a motor 88 (not shown in FIG. 1, but shown in FIG. 5) being transmitted to at least one of the rollers 37 and 38, which the belt 30 is set around, and the recording paper 16 held on the belt 30 is conveyed from right to left in FIG. 1.

Furthermore, idle rollers 40 are provided on the belt suction conveyance unit 32 so as to correspond with the pressure rollers 20, and therefore, in the pressurization process (leveling process) region facing the pressurization rollers 20, the recording medium 16 suctioned and held on the belt 30 is kept flat and closely suctioned to the belt during the pressurization process.

Since ink adheres to the belt 30 when a marginless print job or the like is performed, a belt-cleaning unit (not shown) is disposed in a predetermined position (a suitable position outside the printing area) on the exterior side of the belt 30. Although the details of the configuration of the belt-cleaning unit are not shown, examples thereof include a configuration in which the belt 30 is nipped with cleaning rollers such as a brush roller and a water absorbent roller, an air blow configuration in which clean air is blown onto the belt 30, or a combination of these. In the case of the configuration in which the belt 30 is nipped with the cleaning rollers, it is preferable to make the line velocity of the cleaning rollers different than that of the belt 30 to improve the cleaning effect.

The inkjet recording apparatus 10 can comprise a roller nip conveyance mechanism, in which the recording paper 16 is pinched and conveyed with nip rollers, instead of the belt suction conveyance unit 32. However, there is a drawback in the roller nip conveyance mechanism that the print tends to be smeared when the printing area is conveyed by the roller nip action because the nip roller makes contact with the printed surface of the paper immediately after printing. Therefore, the belt suction conveyance in which nothing comes into contact with the image surface in the printing area is preferable.

Furthermore, it is also possible to use conveyance by electrostatic attraction which attracts and holds the recording paper 16 on a belt 30 by means of electrostatic attraction. In one mode of conveyance by electrostatic attraction, electrodes for generating static electricity, and a power supply which supplies voltage to the electrodes are provided, instead of the suction apertures, suction chamber and pump.

A heating fan (not shown) is disposed on the upstream side of the printing unit 12 in the conveyance pathway formed by the belt suction conveyance unit 32. The heating fan blows heated air onto the recording paper 16 to heat the recording paper 16 immediately before printing so that the ink deposited on the recording paper 16 dries more easily.

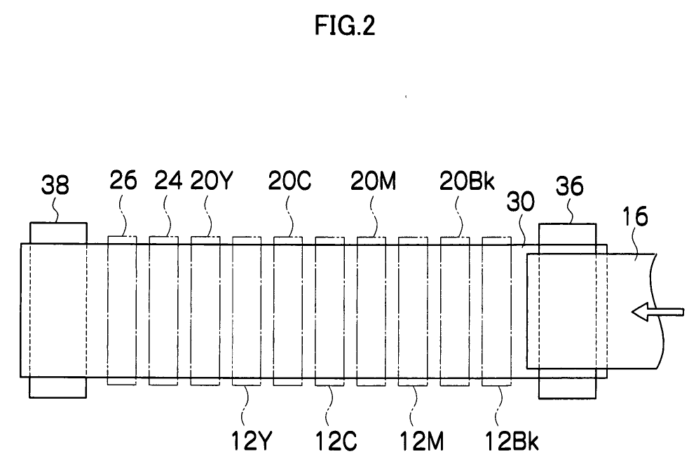

As shown in FIG. 2, the print heads 12Bk, 12M, 12C and 12Y are full line heads having a length corresponding to the maximum width of the recording paper 16 used with the inkjet recording apparatus 10, and comprising a plurality of nozzles for ejecting ink arranged on a nozzle face through a length exceeding at least one edge of the maximum-size recording paper 16 (namely, the full width of the printable range).

The print heads 12Bk, 12C, 12M, and 12Y are arranged in color order (black (Bk), magenta (M), cyan (C), yellow (Y)) from the upstream side in the conveyance direction of the recording paper, and these respective print heads 12Bk, 12M, 12C and 12Y are fixed extending in a direction substantially perpendicular to the conveyance direction of the recording paper.

A color image can be formed on the recording paper 16 by ejecting inks of different colors from the print heads 12Bk, 12C, 12M and 12Y, respectively, onto the recording paper 16 while the recording paper 16 is conveyed by the belt suction conveyance unit 32.

By adopting a configuration in which full line type print heads 12Bk, 12M, 12C and 12Y having nozzles rows covering the full paper width are provided for each separate color in this way, it is possible to record an image on the full surface of the recording paper 16 by performing just one operation of moving the recording paper 16 relatively with respect to the print heads 12Bk, 12M, 12C and 12Y in the conveyance direction of the recording paper, (in other words, by means of one sub-scanning action). A single pass inkjet recording apparatus of this kind is able to print at high speed in comparison with a shuttle scanning system in which an image is printed by moving a print head back and forth reciprocally in the main scanning direction, and hence print productivity can be improved.

Although a configuration with four standard colors, K(Bk), M, C and Y, is described in the present embodiment, the combinations of the ink colors and the number of colors are not limited to these, and light and/or dark inks can be added as required. For example, a configuration is possible in which print heads for ejecting light-colored inks such as light cyan and light magenta are added. Furthermore, there are no particular restrictions on the sequence in which the print heads of respective colors are arranged.

Furthermore, in the present embodiment, ultraviolet-curable ink is used for the printing inks. The ultraviolet-curable ink has properties whereby the hardening (polymerization) of the ink is promoted by application of ultraviolet energy irradiated from-the preliminary curing light sources 22Bk, 22M, 22C and 22Y, and the main curing light source 24.

As shown in FIG. 1, the preliminary curing light sources 22Bk, 22M, 22C and 22Y provided inside the pressurization rollers 20Bk, 20M, 20C and 20Y and the main curing light source 24 disposed on the downstream side of the print unit 12 in the recording paper conveyance direction has a length corresponding to the maximum paper width of the recording paper 16, similarly to the print heads 12Bk, 12M, 12C and 12Y, and it is fixed so as to extend in a direction substantially perpendicular to the paper conveyance direction.

For example, the preliminary curing light sources 22Bk, 22M, 22C and 22Y and the main curing light source 24 are respectively constituted by a configuration of ultraviolet lit-emitting diode (LED) elements or ultraviolet laser diode (LD) elements arranged in a line. According to this composition, since light emission can be controlled selectively in each individual light-emitting element, it is possible readily to adjust the light emitting elements that light up, and the amount of light generated, and hence a prescribed irradiation range and light volume (intensity) can be achieved in the ultraviolet irradiation area.

The ink droplets 18 deposited on the recording paper 16 are cured preliminarily to a degree whereby a hardened film (hardened layer) is formed on the surface by the ultraviolet light (energy) irradiated from the preliminary curing light sources 22Bk, 22M, 22C and 22Y In other words, the irradiation level (irradiation energy) of the preliminary curing light sources 22Bk, 22M, 22C and 22Y is set in such a manner that they cure the ink droplets 18 deposited onto the recording paper 16 to a liquid state (gel state) of a level whereby a hardened film is formed on the surface of the ink droplets 18.

The ink droplets 18 cured preliminarily in this manner are leveled to a uniform thickness (height) by the pressure applied by the pressurization rollers 20Bk, 20M, 20C and 20Y, and they then undergo a main curing process by the ultraviolet irradiated from the main curing light source 24.

Desirably, when the ink droplets are irradiated with ultraviolet light by the main curing light source 24, they proceed to become cured and fixed to a degree whereby no image deterioration occurs during handling in subsequent processing on the downstream side in the paper conveyance direction. Here, this “handling” means, for example, (1) rubbing of the image surface against the rollers, conveyance guides, and the like, in the conveyance steps downstream of the main curing light source 24, (2) rubbing between prints in the print stacking section, and (3) rubbing of a finished print against various objects when it is actually handled for use.

A mode is also possible in which other radiation sources, such as electron beams (EB), are provided instead of the preliminary curing light sources 22Bk, 22M, 22C and 22Y and the main curing light source 24, and ink having properties whereby the curing of the ink is promoted by the radiation source is used. The details of the pressurization rollers 20Bk, 20M, 20C and 20Y and the preliminary curing light sources 22Bk, 22M, 22C and 22Y are described hereinafter.

The present embodiment describes a mode in which the preliminary curing light sources 22Bk, 22M, 22C and 22Y and the main curing light source 24 has the same composition (or a similar composition), but it is also possible to use light sources having different compositions for the preliminary curing light sources 22Bk, 22M, 22C and 22Y and the main curing light source 24.

The print determination unit 26 is provided on the downstream side of the main curing light source 24. The print determination unit 26 has an image sensor for capturing an image of the ink droplet deposition result of the print unit 12, and functions as a device to check for ejection defects such as blockages of the nozzles in the print unit 12 on the basis of the ink droplet deposition results evaluated by the image sensor. The ejection determination includes the presence of the ejection, measurement of the dot size, and measurement of the dot deposition position.

The print determination unit 26 of the present embodiment is configured with at least a line sensor having rows of photoelectric transducing elements with a width that is greater than the ink-droplet ejection width (image recording width) of the print heads 12Bk, 12M, 12C, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

In this way, the recording paper 16 (the created printed matter) that has passed the print determination unit 26 is output from the paper output unit 34 via nip rollers 42. Although not shown in FIG. 1, the paper output unit 34 is provided with a sorter for collecting images according to print orders.

Structure of Print Head

Next, the structure of a print head will be described. The print heads 12Bk, 12M, 12C and 12Y provided for the respective ink colors have the same structure, and a reference numeral 50 is hereinafter designated to any of the print heads 12K, 12C, 12M and 12Y.

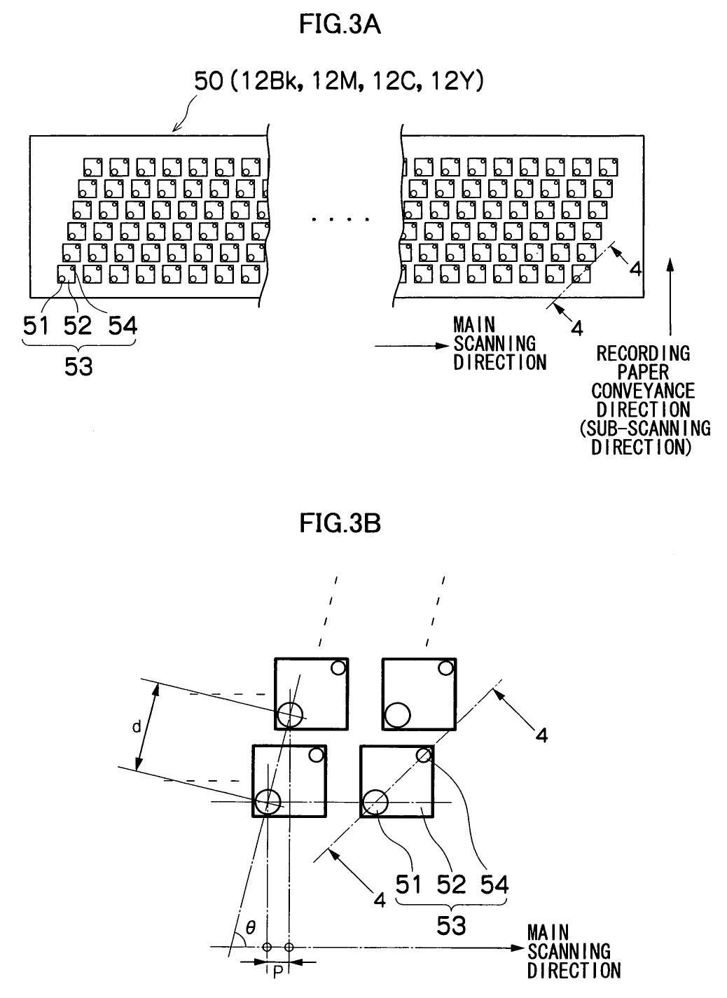

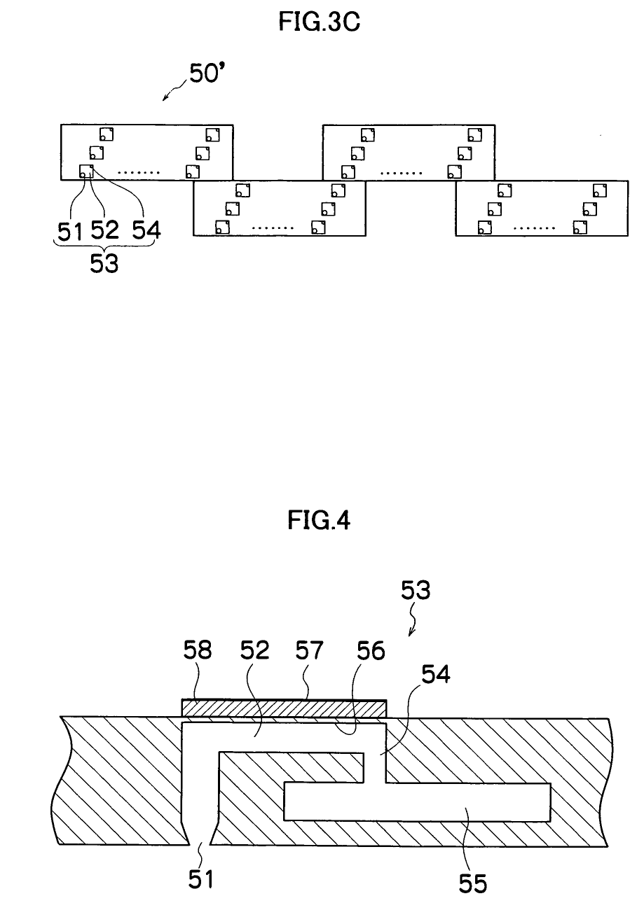

FIG. 3A is a plan perspective view showing an example of the composition of a print head 50, and FIG. 3B is an enlarged diagram of a portion of same. Furthermore, FIG. 3C is a plan perspective view showing a further example of the composition of a print head 50, and FIG. 4 is a cross-sectional diagram showing a three-dimensional composition of an ink chamber unit (being a cross-sectional view along line 4-4 in FIGS. 3A and 3B).

In order to achieve a high density of the dot pitch printed onto the surface of the recording paper 16, it is necessary to achieve a high density of the nozzle pitch in the print head 50. As shown in FIGS. 3A to 3C and FIG. 4, the print head 50 according to the present embodiment has a structure in which a plurality of ink chamber units53, each comprising a nozzle 51 forming an ink droplet ejection port, a pressure chamber 52 corresponding to the nozzle 51, and the like, are disposed two-dimensionally in the form of a staggered matrix, and hence the effective nozzle interval (the projected nozzle pitch) as projected in the lengthwise direction of the head (the direction perpendicular to the paper conveyance direction; in other words, the main scanning direction), is reduced (high nozzle density is achieved).

For example, instead of the composition in FIGS. 3A and 3B, as shown in FIG. 3C, a full line head having nozzle rows of a length corresponding to the entire length of the recording paper 16 can be formed by arranging and combining, in a staggered matrix, short head units 50'each having a plurality of nozzles 51 arrayed in a two-dimensional fashion.

The pressure chamber 52 provided corresponding to each of the nozzles 51 is approximately square-shaped in plan view, and a nozzle 51 and a supply port 54, which is an inlet port for the supplied ink; are provided respectively at either corner of a diagonal of the pressure chamber 52.

As shown in FIG. 4, each pressure chamber 52 is connected to a common flow passage 55 via the supply port 54. The common flow channel 55 is connected to an ink tank (not shown), which is a base tank that supplies ink, and the ink supplied from the ink tank is delivered through the common flow channel 55 shown in FIG. 4 to the pressure chambers 52.

An actuator 58 provided with an individual electrode 57 is joined to a pressure plate (also serving as a common electrode) 56 which forms the ceiling of the pressure chamber 52, and the actuator 58 is deformed to change the volume of the pressure chamber 52 when a drive voltage is applied to the individual electrode 57 and a common electrode 56, thereby causing ink to be ejected from the nozzle 51. A piezoelectric body, such as a piezo element, is suitable as the actuator 58. When ink is ejected, new ink is supplied to the pressure chamber 52 from the common flow channel 55 through the supply port 54.

As shown in FIG. 3B, the plurality of ink chamber units 53 having this structure are composed in a lattice arrangement, based on a fixed arrangement pattern having a row direction which coincides with the main scanning direction, and a column direction which, rather than being perpendicular to the main scanning direction, is inclined at a fixed angle of θ with respect to the main scanning direction.

More specifically, by adopting a structure in which a plurality of ink chamber units 53 are arranged at a uniform pitch d in line with a direction forming an angle of θ with respect to the main scanning direction, the pitch P of the nozzles projected so as to align in the main scanning direction is d×cos θ, and hence the nozzles 51 can be regarded to be equivalent to those arranged linearly at a fixed pitch P along the main scanning direction. Such configuration results in a nozzle structure in which the nozzle row projected in the main scanning direction has a high nozzle density.

In implementing the present invention, the arrangement of the nozzles is not limited to that of the example illustrated. Moreover, a method is employed in the present embodiment where an ink droplet is ejected by means of the deformation of the actuator 58, which is typically a piezoelectric element; however, in implementing the present invention, the method used for discharging ink is not limited in particular, and instead of the piezo method, it is also possible to apply various types of methods, such as a thermal jet method where the ink is heated and bubbles are caused to form therein by means of a heat generating body such as a heater, ink droplets being ejected by means of the pressure applied by these bubbles.

Description of Control System

Next, the control system of the inkjet recording apparatus 10 will be described.

FIG. 5 is a principal block diagram showing the system configuration of the inkjet recording apparatus 10. The inkjet recording apparatus 10 comprises a communication interface 70, a system controller 72, an image memory 74, a motor driver 76, a heater driver 78, a print controller 80, an image buffer memory 82, a head driver 84, a light source driver 85, and the like.

The communication interface 70 is an interface unit for receiving image data sent from a host computer 86. A serial interface such as USB, IEEE1394, Ethernet, wireless network, or a parallel interface such as a Centronics interface may be used as the communication interface 70. A buffer memory (not shown) may be mounted in this portion in order to increase the communication speed.

The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic recording medium may be used.

The system controller 72 is a control unit for controlling the various sections, such as the communications interface 70, the image memory 74, the motor driver 76, the heater driver 78, and the like. The system controller 72 is constituted by a central processing unit (CPU) and peripheral circuits thereof, and the like, and in addition to controlling communications with the host computer 86 and controlling reading and writing from and to the image memory 74, or the like, it also generates a control signal for controlling the motor 88 of the conveyance system and the heater 89.

The motor driver 76 is a driver (drive circuit) which drives the motor 88 in accordance with instructions from the system controller 72. Furthermore, the heater driver 78 is a driver for driving the heater 89 of a heating drum, and other sections, in accordance with instructions from the system controller 72.

The motor 88 shown in FIG. 5 includes a motor for driving the rollers 37 and 38 of the belt suction conveyance unit 32 and a plurality of motors belonging to other conveyance systems and drive systems. Similarly, the heater 89 shown in FIG. 5 includes a heater of the heating drum, and a plurality of other heaters, such as a heater for adjusting the temperature of the print head 50, and the like.

FIG. 5 shows a motor 88 and a heater 89 as representative examples of this plurality of motors and plurality of heaters.

The print controller 80 has a signal processing function for performing various tasks, compensations, and other types of processing for generating print control signals from the image data stored in the image memory 74 in accordance with commands from the system controller 72 so as to supply the generated print control signals (dot data) to the head driver 84. Prescribed signal processing is carried out in the print controller 80, and the ejection amount and the ejection timing of the ink droplets from the print heads 12Bk, 12M, 12C, and 12Y for respective colors are controlled via the head driver 84, on the basis of the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80. The aspect shown in FIG. 5 is one in which the image buffer memory 82 accompanies the print controller 80; however, the image memory 74 may also serve as the image buffer memory 82. Also possible is an aspect in which the print controller 80 and the system controller 72 are integrated to form a single processor.

The head driver 84 drives the actuators 58 which drive ejection in the respective print heads 50, on the basis of the dot data supplied from the print controller 80. A feedback control system for maintaining constant drive conditions for the print heads may be included in the head driver 84.

The image data to be printed is externally inputted through the communications interface 70, and is stored in the image memory 74. At this stage, RGB image data is stored in the image memory 74, for example. The image data stored in the image memory 74 is sent to the print controller 80 through the system controller 72, and is converted into dot data for each ink color by a known dithering algorithm, random dithering algorithm or another technique in the print controller 80.

The print head 50 is driven on the basis of the dot data thus generated by the print controller 80, so that ink is ejected from the head 50. By controlling ink ejection from the print head 50 in synchronization with the conveyance speed of the recording paper 16, an image is formed on the recording paper 16.

In this inkjet recording apparatus 10, the type and size of the recording paper 16 is determined by means of a media determination unit (not shown). This section uses, for example, a device for reading in information such as bar codes attached to the magazine in the paper supply unit 28, or sensors disposed at a suitable position in the paper conveyance path (a paper width determination sensor, a sensor for determining the thickness of the paper, a sensor for determining the reflectivity of the paper, and so on). A suitable combination of these elements may also be used. Furthermore, it is also possible to adopt a composition in which information relating to the paper type, size, or the like, is specified by means of inputs made via a prescribed user interface, instead of or in conjunction with such automatic determination devices.

Information obtained by the media determining section is reported to the system controller 72 and/or the print controller 80, and is used to control ink ejection.

A light source driver 85 controls the switching on and switching off of the preliminary curing light sources 22Bk, 22M, 22C and 22Y and the main curing light source 24, and the switch on and switch off timings, the amount of light emitted by the light sources, and the like, in accordance with instructions from the print controller 80.

Composition of Pressurization Rollers and Preliminary Curing Light Sources

Next, the pressurization rollers 20Bk, 20M, 20C and 20Y and the preliminary curing light sources 22Bk, 22M, 22C and 22Y shown in FIG. 1 will be described in detail. Since the pressurization rollers 20Bk, 20M, 20C and 20Y and the preliminary curing light sources 22Bk, 22M, 22C and 22Y have common compositions, below, a representative pressurization roller is indicated by reference numeral 20, and a representative preliminary curing light source provided inside the pressurization roller 20 is indicated by reference numeral 22.

FIG. 6 shows the composition of a pressurization roller 20 and preliminary curing light source 22 provided in the inkjet recording apparatus 10 shown in FIG. 1, and the periphery of same. In FIG. 6, items which are the same as or similar to those in FIG. 1 are labeled with the same reference numerals and description thereof is omitted here.

Furthermore, the preliminary curing light source 22 shown in FIG. 6 depicts one of the light-emitting elements arranged in a line fashion.

As shown in FIG. 6, a thin film can be formed on the surface of the ink droplets 18 deposited onto the recording paper 16, by means of the ultraviolet light irradiated from the preliminary curing light source 22 provided inside the pressurization roller 20, and thus a preliminary curing process is performed which hardens the ink to a degree whereby it does not become attached to the surface of the pressurization roller (the pressurization surface), when it makes contact with the pressurization roller 20. Reference numeral 18A shown in FIG. 6 indicates an ink droplet which has undergone a preliminary curing process.

The pressurization roller 20 presses the ink droplet 18A having undergone a preliminary curing process, in the direction of the recording paper 16 (the direction indicated by arrow P in FIG. 6), and hence the dome-shaped ink droplet 18A is compressed and the apex (peak) portion thereof becomes flat. Thereby, the height (thickness) of the ink droplet 18A becomes lower than its original height, and leveling is achieved in such a manner that each of the ink droplets has a uniform height. This reduces the step difference between regions of the recording paper 16 where an image is formed (a region where ink droplets have been deposited) and regions of the recording paper 16 where no image has been formed and the surface of the paper is exposed. The reference numeral 18B in FIG. 6 indicates an ink droplet in a region where the leveling process has been performed.

By carrying out a leveling process of this kind, it is possible to prevent conspicuous relief effects from appearing in the image, and furthermore, the thickness of the respective ink droplets can be made uniform by the leveling process.

On the other hand, during the leveling process performed by the pressurization roller 20, since the ink droplets to be pressed are cured to a degree whereby a film is formed on the surface thereof, then it is possible to prevent scattering of the ink droplets, or attachment of the ink droplets to the surface of the pressurization roller 20 (the ink pressurization surface), when they come into contact with the pressurization roller 20. Furthermore, since the ink droplets are not completely cured, a leveling process can be performed readily by means of pressurization.

A member which transmits the ultraviolet light, such as a transparent member, or the like, is used for the pressurization roller 20, in such a manner that the ultraviolet light emitted from the preliminary curing light source 22 contained therein is transmitted through the pressurization roller and irradiated onto the ink droplets on the recording medium 16. For the ultraviolet light transmitting member, it is possible to use a resin material, such as a plastic, or glass, or the like.

Of course, it is also possible to compose the part of the pressurization roller 20 which transmits the ultraviolet light by means of the aforementioned ultraviolet light transmitting member, and to compose the remaining sections of the pressurization roller 20 from other members.

Moreover, a pressure changing mechanism (not shown) for changing the pressure applied to the ink droplets 18A is provided in the pressurization roller 20. This pressure changing mechanism comprises a movement mechanism which moves the pressurization roller 20 in the vertical direction in FIG. 6 (the direction indicated by arrow H in FIG. 6), in such a manner that the clearance between the pressurization roller 20 and the recording medium 16 (belt 30) is altered.

Of course, it is also possible to adopt other modes for the pressure changing mechanism. For example, the pressurization region of the pressurization roller 20 may be composed in an expandable and contractable fashion, in such a manner that the volume thereof can be changed by filling a gas, such as air, or a liquid, into this section, thereby raising the pressure applied to the ink droplets.

Irradiation of ultraviolet light from the preliminary curing light source 22 onto the ink droplets 18 (18A and 18B) continues during the leveling process by the pressurization roller 20 and immediately after the leveling process. In other words, since ultraviolet light is irradiated from the preliminary curing light source 22 onto the ink droplets 18 (18A and 18B) on the recording paper 16, from immediately before the leveling process until immediately after the leveling process, the ink droplets are cured preliminarily before the leveling process, and furthermore, the interior of the ink droplets can also be cured after the leveling process. Therefore, the shape of the ink droplets obtained by the leveling process is maintained.

A cleaning blade 100 which eliminates ink droplets or foreign matter attached to the surface of the pressurization roller 20, and a cleaning section 104 including a recovery tray 102 which recovers the ink droplets or foreign matter removed by the cleaning blade 100, are provided on the downstream side of the pressurization roller 20 in the recording paper conveyance direction.

The present embodiment described a mode in which ink, and the like, attached to the surface of the pressurization roller 20 is removed by wiping, but it is also possible to remove the ink, and the like, by blowing air, or the like, onto the surface of the pressurization roller, or alternatively, the ink can be removed by suctioning, using a suctioning member such as a sponge.

Furthermore, a desirable mode is one in which the amount of wear of the cleaning blade is determined, and a restoration process for replacing or grinding the cleaning blade, or the like, is carried out if the amount of wear exceeds a prescribed range. The amount of wear may be determined by directly measuring the length (thickness) of the front tip portion of the cleaning blade, or by inferring indirectly from the use time period (elapsed time), the amount of ink collected in the recovery tray 102, or the like. Furthermore, a composition may be adopted wherein, if a restoration process is required for the cleaning blade, then a message to this effect is reported to the user.

By imparting liquid repelling properties to the surface of the pressurization roller 20, it is possible to increase the ink removing capability. As the mode of imparting liquid repelling properties to the pressurization roller 20, a member having liquid repelling properties may be used for the surface of the pressurization roller 20, or a liquid repelling process may be applied to the surface of the pressurization roller 20.

In the present embodiment, the pressurization roller 20 is depicted as a device for pressurizing the ink droplets on the recording paper 16, but the device for pressurizing the ink droplets on the recording medium 16 is not limited to the form of a roller, and it is also possible to adopt a plate-shaped press or a member having another form.

Description of Preliminary Curing Light Source

Next, the preliminary curing light source 22 is described.

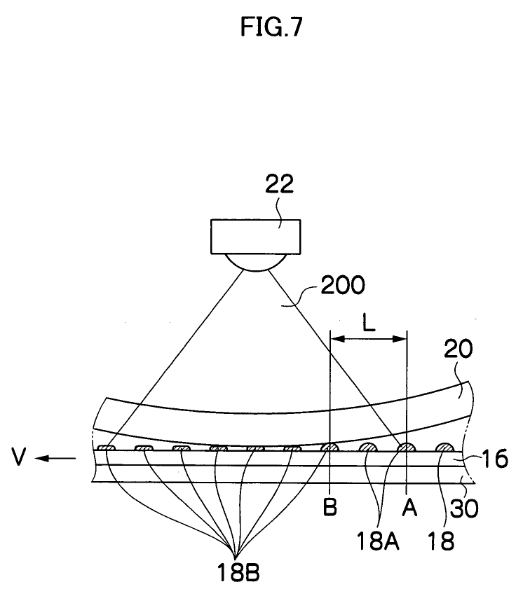

FIG. 7 shows the ultraviolet light emitted from the preliminary curing light source 22 and the irradiation region of this ultraviolet light on the recording paper 16. The ultraviolet light emitted from the preliminary curing light source 22 is emitted in a radiating beam from a point-shaped light source, as indicated by reference numeral 200 in FIG. 7.

Here, the relationship between the distance, L, from the ultraviolet irradiation start point A of the ink droplets on the recording paper 16 to the pressurization start point B by the pressurization roller 20, the conveyance speed V of the recording paper 16, and the time T1 from the start of ultraviolet light irradiation to the start of pressurization, satisfies the following relationship (1): T1=L/V.

Furthermore, if T2 is taken to be the time period from the start of ultraviolet light irradiation until the time at which a thin film has formed on the surface of the ink droplet (until preliminary curing of the ink droplet has progressed and has reached a condition which allows it to be pressurized by the pressurization roller 20) under given ultraviolet light irradiation conditions, then it is possible to prevent adherence of ink to the surface of the pressurization roller if the following relationship (2) is satisfied: T1>T2 .

On the other hand, if T3 is taken to be the time period from the start of irradiation of ultraviolet light until the time at which curing of the ink droplet has progressed to a level whereby leveling of the ink droplet due to pressurization by the pressurization roller becomes difficult, under given ultraviolet light irradiation conditions, then in order for leveling of the ink droplet by the pressurization roller 20 to be possible, time periods T1 and T3 described above should satisfy the following relationship (3): T1<T3.

More specifically, from the relationships (2) and (3), the time period T1 from the start of irradiation of the ultraviolet light until the start of pressurization satisfies the following relationship (4): T2<T1<T3 .

For example, if T2=0.005 sec, T3=0.05 sec and V=200 mm/sec, then the values of T1 and L described above satisfy the relationship (5): 0.005 sec<T1<0.05 sec, and the relationship (6): 1 mm<L<10 mm.

The system controller 72 and the print controller 80 shown in FIG. 5 control the amount of light Q (amount of irradiation energy) of the preliminary curing light source 22, and the conveyance speed V, in such a manner that the conditions stated in (1) to (6) described above are satisfied.

In other words, the preliminary curing light source 22 must be situated in such a manner that ultraviolet light is irradiated onto the ink droplets 18, thereby curing the ink droplets 18 preliminarily, before the ink droplets 18 start to be pressurized by the pressurization roller 20. However, if the preliminary curing light source 22 is located on the upstream side of the pressurization roller 20 in the conveyance direction of the recording paper, then the distance L from the start position of ultraviolet light irradiation until the pressurization start position becomes larger, and it becomes difficult to satisfy the condition stated in (6). Therefore, by providing the preliminary curing light source 22 inside the pressurization roller 20 as shown in FIG. 1 and other drawings, then it is possible to shorten the distance, L, from the ultraviolet light irradiation start position to the pressurization start position, and therefore it is possible to satisfy the condition stated in (6).

Furthermore, by providing the preliminary curing light source 22 inside the pressurization roller 20, the ultraviolet light can be irradiated continuously onto the ink droplets on the recording paper 16, from the start of pressurization until the end of pressurization. Therefore, it is possible to accelerate curing of the ink droplets 18B shown in FIG. 7, while maintaining the shape of the ink droplets which have been leveled by the pressurization roller 20.

Next, the control of the amount of ultraviolet light emitted by the preliminary curing light source 22 will be described.

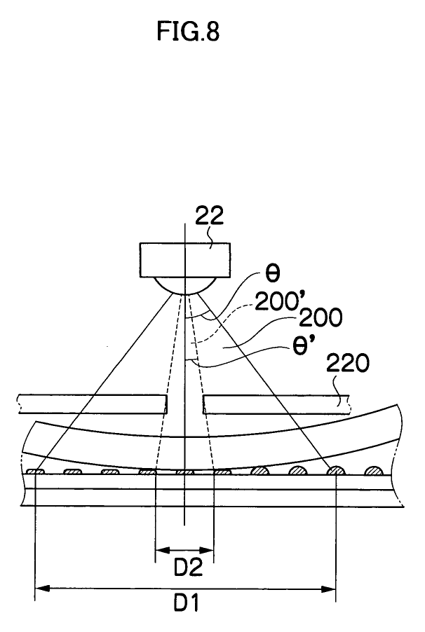

FIG. 8 shows a mode where an opening and closing mechanism 220, such as a shutter, which functions as a light amount adjustment mechanism and an irradiation range adjustment mechanism, is provided between the pressurization roller 20 and the preliminary curing light source 22. By varying the open and closed state of the opening and closing mechanism 220, it is possible to change the amount of ultraviolet light Q irradiated onto the recording paper 16 and the ultraviolet light irradiation range on the recording paper 16.

More specifically, by setting the opening and closing mechanism 220 to a fully opened state, then the ultraviolet light irradiated onto the recording paper 16 will be as indicated by reference numeral 200 shown by the solid line in FIG. 8, and in this case, the angle of irradiation of the ultraviolet light will be θ. Furthermore, in this state, the range (length) of irradiation of the ultraviolet light on the recording paper 16 in a direction substantially parallel to the direction of conveyance of the recording paper, will be D1.

On the other hand, in an intermediate state in which the opening and closing mechanism 220 has been closed from the fully opened state (namely, an intermediate state between the fully opened state and closed state), the ultraviolet light irradiated onto the recording paper 16 will be as indicated by reference numeral 200'shown by the dotted line in FIG. 8. Furthermore, in this state, the range of irradiation of the ultraviolet light on the recording paper 16 in a direction substantially parallel to the direction of conveyance of the recording paper will be D2, which is shorter than D1 described above.

In other words, by varying the amount of opening of the opening and closing mechanism 220, it is possible to vary the amount of ultraviolet light irradiated onto the recording paper 16 and the range of irradiation of the ultraviolet light on the recording paper 16.

If a composition is adopted in which the amount of ultraviolet light Q irradiated onto the recording paper 16 and the range of irradiation of ultraviolet light (the angle of irradiation of the ultraviolet light) on the recording paper 16 are variable, then desirably, the ink droplets on the recording paper 16 are cured preliminarily in accordance with the type of ink, the type of recording paper (recording medium), and the environmental conditions (temperature, humidity, and the like).

Furthermore, since a pressurization roller 20 and preliminary curing light source 22 are provided respectively for each print head 50 (12Bk, 12M, 12C and 12Y), then even if the ink properties are different for each respective color, it is possible to optimize the preliminary curing state of the ink droplets of each color, by altering the amount of ultraviolet light and the range of irradiation of the ultraviolet light according to the ink properties.

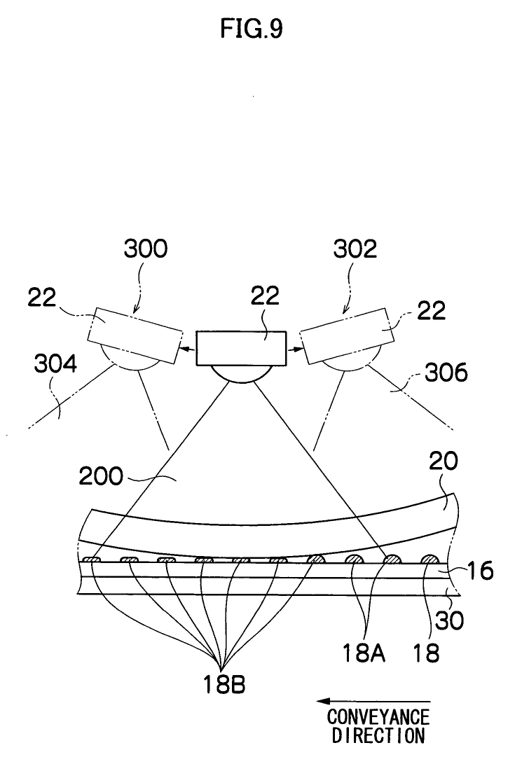

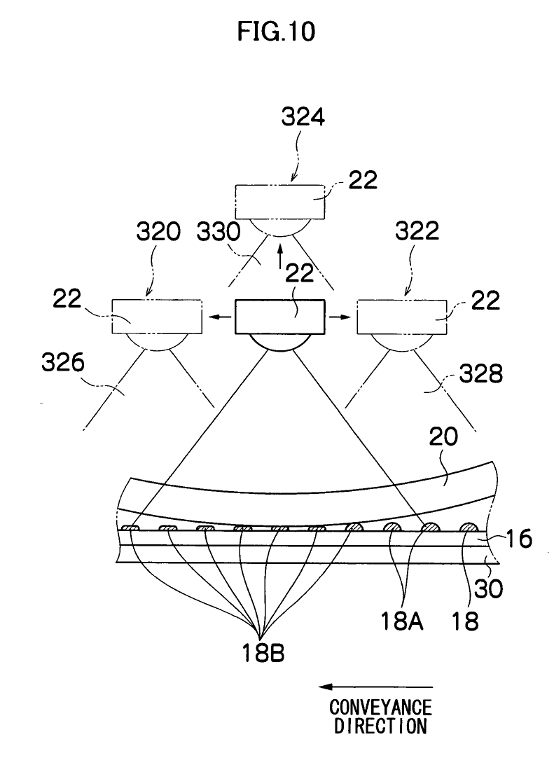

FIG. 9 and FIG. 10 shows a mode where a movement mechanism (not shown) for moving the preliminary curing light source 22 is provided, the preliminary curing light source 22 being moved by this movement mechanism, thereby altering the amount of ultraviolet light Q irradiated onto the recording paper 16 and the range of irradiation of the ultraviolet light.

FIG. 9 shows a mode where the preliminary curing light source 22 is rotated in the direction of rotation of the pressurization roller 20 (the direction of rotation indicated by the arrow in FIG. 9). In FIG. 9, reference numeral 300 indicated by the double-dotted line shows a preliminary curing light source 22 in a position where it has been rotated (moved) through a prescribed angle in the clockwise direction, from the position shown in FIG. 8, and reference numeral 302 shows a preliminary curing light source 22 in a position where it has been rotated through a prescribed angle in the anticlockwise direction. Furthermore, reference numeral 304 shows the ultraviolet light irradiated from the preliminary curing light source 22 in the position indicated by reference numeral 300, and reference numeral 306 shows the ultraviolet light irradiated from the preliminary curing light source 22 in the position indicated by the reference numeral 302.

As shown in FIG. 9, by rotating the preliminary curing light source 22 in the direction of rotation of the pressurization roller 20, it is possible to move the region of irradiation of the ultraviolet light on the recording paper 16, in the leftward and rightward direction in FIG. 9.

FIG. 10 shows a mode in which the preliminary curing light source 22 is slid (moved in a parallel fashion) in a direction substantially parallel to the conveyance direction of the recording paper (the leftward and rightward direction in FIG. 10), and in a direction substantially perpendicular to the conveyance direction of the recording paper (the upward and downward direction in FIG. 10).

The reference numeral 320 indicated by the double-dotted line in FIG. 10 shows the preliminary curing light source 22 in a position where it has been moved in a direction substantially parallel to the conveyance direction of the recording paper, and reference numeral 322 shows the preliminary curing light source 22 when it has been moved in the opposite direction to the position shown by reference numeral 320. Furthermore, reference numeral 324 shows the preliminary curing light source 22 in a position where it has been moved to a direction substantially perpendicular to the recording paper conveyance direction.

As shown in FIG. 10, by sliding the preliminary curing light source 22 in the upward, downward, leftward and rightward directions, it is possible to move the region of irradiation of the ultraviolet light on the recording paper 16. Reference numeral 326 in FIG. 10 shows the ultraviolet light irradiated from the preliminary curing light source 22 when it has been moved to the position indicated by reference numeral 320, and reference numerals 328 and 330 show the ultraviolet light emitted from the preliminary curing light source 22 when it has been moved to the positions indicated respectively by reference numerals 322 and 324. Moreover, by moving the preliminary curing light source 22 in the upward and downward direction, the interval between the preliminary curing light source 22 and the recording paper 16 changes, and the amount of ultraviolet light Q irradiated onto the recording medium 16 changes.

For example, if the preliminary curing light source 22 is moved in the upward direction in FIG. 10, then the interval between the preliminary curing light source 22 and the recording paper 16 increases, and the amount of ultraviolet light Q irradiated onto the recording paper 16 decreases compared to the case before movement of the preliminary curing light source 22.

On the other hand, if the preliminary curing light source 22 is moved in the downward direction in FIG. 10, then the interval between the preliminary curing light source 22 and the recording paper 16 decreases, and the amount of ultraviolet light Q irradiated onto the recording paper 16 increases compared to the amount before movement.

In the mode shown in FIG. 9, or when the preliminary curing light source 22 has been moved to the position indicated by reference numeral 324 in FIG. 10, there may be a decrease in the amount of ultraviolet light Q irradiated onto the recording paper 16, in comparison with a case where the preliminary curing light source 22 is situated in its original position. Therefore, control should be implemented in such a manner that the amount of ultraviolet light emitted from the preliminary curing light source 22 is increased in accordance with the movement position of the preliminary curing light source 22.

Furthermore, if the conveyance speed V of the recording paper 16 is variable, then the time period during which ultraviolet light is irradiated onto the recording paper 16 can be changed, and therefore, the preliminary curing state of the ink droplets 18 on the recording paper 16 can be altered.

In other words, if the conveyance speed of the recording paper 16 is increased, then the ultraviolet light irradiation time becomes shorter, and the thickness of the film formed on the surface of the ink droplets 18 decreases (preliminary curing progresses more slowly). On the other hand, if the conveyance speed of the recording paper 16 is slowed, then the ultraviolet light irradiation time becomes longer, and the thickness of the film formed on the surface of the ink droplets 18 increases (preliminary curing progresses more quickly).

In the inkjet recording apparatus 10 having the composition described above, an image is formed on the recording paper 16 (ink droplets are discharged onto the recording paper 16) by using an ultraviolet-curable ink, and the ink droplets 18 deposited onto the recording paper 16 are subjected to a leveling process by means of a pressurization roller 20. Therefore, step differences between image forming regions and non-image forming regions on the recording paper 16 are reduced, and relief effects appearing in the image are suppressed.

Furthermore, since a preliminary curing light source 22 is provided inside the pressurization roller 20, and the pressurization roller 20 is made from a member that transmits ultraviolet light, then the ink droplets deposited on the recording paper 16 are subjected to a preliminary curing process by the preliminary curing light source 22 prior to the leveling process by the pressurization roller 20, and therefore adherence of ink to the surface of the pressurization roller 20 can be prevented.

Moreover, since ultraviolet light is irradiated onto the ink droplets on the recording paper 16 from the preliminary curing light source 22, during the leveling process and after the leveling process, it is possible to maintain the shape of the ink droplets after the leveling process.

Since a composition is adopted in which the pressure applied to the ink droplets during the leveling process by the pressurization roller 20 is variable, then the printing height (thickness of the ink droplets) can be adjusted in accordance with the print objective (image).

Modification Example

Next, a modification example of the inkjet recording apparatus 10 according to the present embodiment will be described.

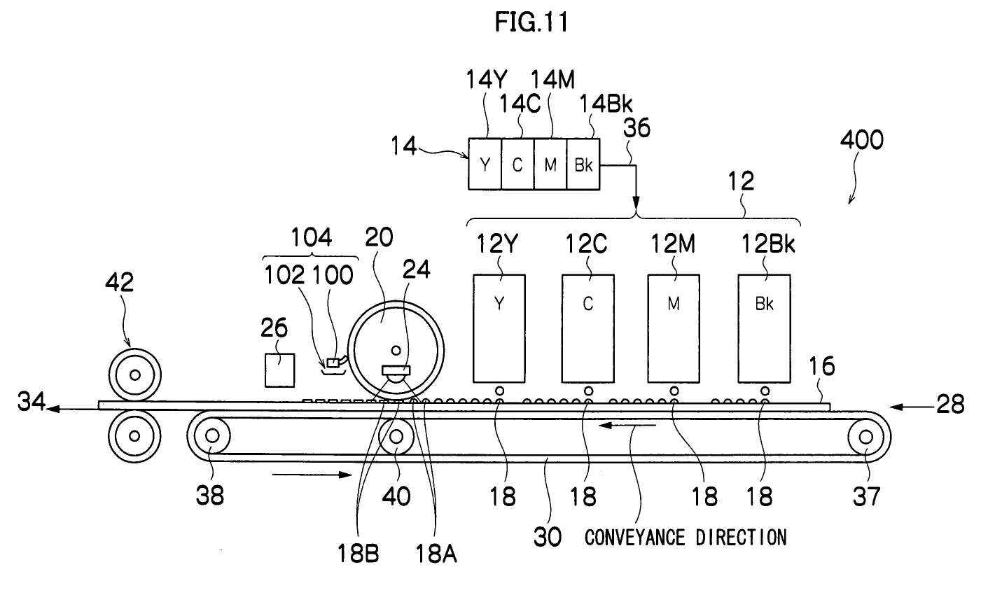

FIG. 11 is a diagram of the general composition of an inkjet recording apparatus relating to a modification of the present embodiment. In FIG. 11, items which are the same as or similar to those in FIG. 1 are labeled with the same reference numerals and description thereof is omitted here.

The inkjet recording apparatus 400 shown in FIG. 11 depicts a mode in which a pressurization roller 20 having a main curing light source 24 provided therein, which is common to the print heads 12Bk, 12M, 12C and 12Y, is disposed on the downstream side of the print unit 12 in the conveyance direction of the recording paper.

Moreover, in the mode shown in FIG. 11, the preliminary curing light source 22 is combined with the main curing light source 24, and no preliminary curing light source 22 is provided.

By means of the composition shown in FIG. 11, it is possible to reduce the number of pressurization rollers 20 and preliminary curing light sources 22, and therefore the apparatus composition can be simplified.

In the present embodiment, an inkjet recording apparatus which records images onto a recording media by means of ink ejection from nozzles provided in a print head has been described, but the scope of application of the present invention is not limited to this, and it may also be applied broadly to liquid ejection apparatuses (dispensers, and the like), which eject a liquid (resist or the like) of which curing can be promoted by irradiation of ultraviolet light, onto ejection receiving media (wafers, printed substrates, and the like).

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image recording apparatus, comprising:
a recording head which ejects a recording liquid having properties of being cured by irradiation of radiation, onto a recording medium;
a relative conveyance device which causes the recording head and the recording medium to move relatively to each other in a relative conveyance direction;
a radiation irradiating device which irradiates the radiation onto recording liquid deposited on the recording medium; and
a pressurization device which pressurizes the recording liquid which has been irradiated with the radiation, the pressurization device being provided on a downstream side of the recording head in the relative conveyance direction of the relative conveyance device, the pressurization device having the radiation irradiating device provided inside thereof and having one of a transmissive member capable of transmitting the radiation emitted from the radiation irradiating device to exterior and a structure capable of transmitting the radiation to the exterior,
wherein a pressurization start position of the pressurization device at which pressurization of the recording liquid on the recording medium starts is situated further to the downstream side of the recording head in the relative conveyance direction of the relative conveyance device than an irradiation start position of the radiation irradiating device.

2. The image recording apparatus as defined in claim 1, wherein the radiation irradiating device cures the recording liquid in such a manner that an interior of the recording liquid on the recording medium has a liquid state or a semi-solidified state.

3. The image recording apparatus as defined in claim 1, further comprising a relative conveyance control device which controls the relative conveyance device in such a manner that a relationship between a time period T1 from a start of the irradiation of the radiation onto the recording liquid on the recording medium from the radiation irradiating device until a start of the pressurization of the recording liquid on the recording medium by the pressurization device, and a time period T2 from the start of the irradiation of the radiation onto the recording liquid on the recording medium from the radiation irradiating device until the recording liquid is cured to a state where an interior of the recording liquid is in a liquid state or a semi-solidified state and the recording liquid is capable of being leveled by the pressurization device, satisfies the following relationship: T1>T2.

4. The image recording apparatus as defined in claim 3, wherein the relative conveyance control device controls the relative conveyance device in such a manner that a relationship between the time period T1, and a time period T3 from the start of the irradiation of the radiation onto the recording liquid on the recording medium from the radiation irradiating device until the recording liquid is fully cured to a state where the recording liquid cannot be leveled by the pressurization device, satisfies the following relationship: T1<T3 .

5. The image recording apparatus as defined in claim 1, further comprising a pressure varying device which varies pressure applied to the recording liquid on the recording medium by the pressurization device.

6. The image recording apparatus as defined in claim 1, wherein the pressurization device comprises a recording liquid removal device which removes the recording liquid that has attached to a surface of the pressurization device during pressurization of the recording liquid.

7. The image recording apparatus as defined in claim 1, wherein:
the recording head comprises a plurality of recording heads; and
the pressurization device is provided for each of the recording heads, each pressurization device being disposed on the downstream side of the corresponding recording head in the relative conveyance direction of the relative conveyance device.

8. The image recording apparatus as defined in claim 1, wherein:
the recording head comprises a plurality of recording heads; and
the pressurization device is provided commonly for the plurality of recording heads, on a furthest downstream side of the recording heads in the relative conveyance direction of the relative conveyance device.

9. The image recording apparatus as defined in claim 1, further comprising a movement device which moves the radiation irradiating device in at least one of a direction having a component substantially parallel to the relative conveyance direction of the relative conveyance device, and a direction having a component substantially perpendicular to the relative conveyance direction of the relative conveyance device.

10. The image recording apparatus as defined in claim 9, further comprising:
an amount-of-radiation modification device which modifies an amount of the radiation emitted by the radiation irradiating device; and
an amount-of-radiation modification control device which controls the amount-of-radiation modification device in such a manner that, when the radiation irradiating device is moved by the movement device, an amount of the radiation necessary to cure the recording liquid so that an interior of the recording liquid has a liquid state or a semi-solidified state is irradiated onto the recording liquid on the recording medium, by means of the pressurization device.

11. An image recording method, comprising the steps of:
ejecting a recording liquid having properties of being cured by irradiation of radiation, onto a recording medium;
curing the recording liquid in such a manner that an interior of the recording liquid deposited on the recording medium in the ejecting step has a liquid state or a semi-solidified state; and
pressurizing the recording liquid after the recording liquid has been cured in the curing step in such a manner that the interior of the recording liquid has the liquid state or the semi-solidified state.
